(19) United States
(12) Patent Application Publication
(10) Pub. No.: US 2004/0032663 A1
(43) Pub. Date: Feb. 19, 2004

(54) Wafer level polarization control elements

(76) Inventor: Robert TeKolste, Charlotte, NC (US)

Correspondence Address: DIGITAL OPTICS CORPORATION, 9815 DAVID TAYLOR DRIVE, CHARLOTTE, NC, 28262, US

(21) Appl. No.: 10/231,486

(22) Filed: Aug. 30, 2002

Related U.S. Application Data
(60) Provisional application No. 60/404,165, filed on Aug. 19, 2002.

(51) Int. Cl. G02B 27/10

(52) U.S. Cl. 359/618

(57) ABSTRACT

Polarization control elements are created on a wafer level using patterns formed on the surface of a substrate. These polarization control elements may be the same across the wafer or may be any desired differing orientations. The polarization elements may also be selectively provided on portions of the substrate. The polarization control elements may be integrated with other elements on the wafer level and then singulated.

### CROSS-REFERENCE TO RELATED APPLICATIONS

The present invention claims priority under 35 U.S.C. §119 to U.S. Provisional Application No. 60/404,165 entitled “Wafer Level Polarization Control Elements” filed Aug. 19, 2002, the entire contents of which are hereby incorporated for all purposes.

### BACKGROUND OF THE INVENTION

1. Field of the Invention

The present invention is directed to the creation of patterned polarization control elements and integration of such polarization control elements with other elements on a wafer level and the structures formed thereby.

2. Description of Related Art

Polarization control elements serve may functions in the optical arena. Such polarization control elements include wire grids. Wire grid polarization control elements include multiple parallel conductive electrodes supported by a substrate. In general, a wire grid polarizer will reflect light having an electric field vector parallel to the wires of the grid and transmit light with an electric field perpendicular to the wires of the grid. The wire grid polarizer is characterized by the pitch of the wire, the width of the wire and the thickness of the wire.

Techniques have been developed to create wire grid polarization control elements involving selective heating a substrate in accordance with an interference pattern created thereon, ion machining, and sandwiching a wire grid between two higher refractive index layers. Thus, it is known how to make such wire grid polarization control elements which form a pattern on a surface. Techniques for lithographically creating polarization control elements are known. However, these polarization control elements are typically provided as individual elements, which must then be individually incorporated with other optical elements to form a desired system, e.g., an isolator. As used herein, the term “lithographically” is to mean transferring a pattern from a mask to a layer of resist deposited on a substrate.

Mass production, i.e., creating more than one system simultaneously and then separating into individual systems, of systems incorporating polarization control elements is known, but has been directed to joining polarization plates to bulk components of the same size. This production is then limited by the size of the polarization plates and/or other bulk components being adhered to the polarization plates. As the demand for systems incorporating polarizers increases and the desired size for these systems decreases, a more efficient manner of creating, integrating, aligning and miniaturizing systems having polarization control elements therein is needed.

### SUMMARY OF THE PRESENT INVENTION

The present invention is therefore directed to a method of creating polarization control devices, as well as integrating them with other elements, and the resultant structures made thereby which substantially overcomes one or more of the problems due to the limitations and disadvantages of the related art.

It is an object of the present invention to pattern polarization control elements and integrate them on a wafer level with lithographically formed elements.

It is another object of the present invention to form different polarization control elements in different regions of a substrate.

At least one of these and other objects may be realized by providing an optical device including a substrate, a polarization control element including a pattern formed on a surface of the substrate, and a lithographically created element on the substrate or on another substrate secured thereto. The lithographically created element may be, e.g., a lens, another polarization control element, a splitter, metal pads. The pattern may be in a material on the surface of the substrate or be transferred into the surface of the substrate. Lithography may be used in the formation of the pattern.

The another substrate may include a non-reciprocal rotation mechanism and the optical device may include another polarization control element, the non-reciprocal rotation mechanism being between the polarization control elements. The non-reciprocal rotation mechanism may rotate a polarization of an input beam and polarization planes of the polarization control elements are offset from one another by the degree of rotation present by the non-reciprocal rotation mechanism. The optical device may include a phase retarder, which may be on the same substrate, but opposite surface, as one of the polarization control elements.

At least one of the above and other objects may be realized by providing an optical device including a first polarization control element including a first pattern on a surface of a substrate and a second polarization control element including a second pattern on the surface of the substrate, the first and second patterns being different from one another. At least one of the first and second patterns may be created using lithography. At least one of the first and second patterns may be in a material on the surface of the substrate. At least one of the first and second patterns may be in the surface of the substrate.

At least one of the above and other objects may be realized by providing an optical system including a first substrate receiving a light beam from a light source, a second substrate secured to the first substrate, and an optical isolator in a path of the light beam. The optical isolator includes a first polarization control element including a first pattern on one of the first and second substrates or any substrate secured thereto, a second polarization control element including a second pattern on one of the first and second substrates or any substrate secured thereto, and a non-reciprocal mechanism between the first and second polarization elements. A lithographically created element is on one of the first and second substrates or any substrate secured thereto.

At least one of the above and other objects may be realized by providing a method of making an optical device, the method including forming a plurality of polarization control elements on a first substrate, each polarization control element including a pattern on the first substrate, aligning a second substrate to the first substrate, securing aligned first and second substrates, and singulating secured first and second substrates to form dies including at least one polarization control element.

Elements may be lithographically forming on at least one of the first and second substrates before the aligning. Another plurality of polarizing elements may be formed on the second substrate and sandwiching a non-reciprocal mechanism between the pluralities of polarizing elements on the first and second substrates before the aligning. The non-reciprocal mechanism may be a plurality of mechanisms and the sandwiching includes securing the rejection mechanism to one of the first and second substrates. Further polarization control elements may be formed in the one of the first and second substrates before the aligning. The forming may include using lithography in creating the pattern.

At least one of the above and other objects may be realized by providing a method of making an optical device, the method including creating a first polarization control element on a surface of a substrate, the first polarization control element including a first pattern on the substrate and creating a second polarization control element on the surface of the substrate, the second polarization control element including a second pattern on the substrate, the first and second pattern being different.

The substrate may be singulating the substrate to form dies including at least one polarization control element. The creating of the first and second polarization control elements may include using lithography. An element may be lithographically created on the substrate.

These and other objects of the present invention will become more readily apparent from the detailed description given hereinafter. However, it should be understood that the detailed description and specific examples, while indicating the preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing and other objects, aspects and advantages will be described with reference to the drawings, in which:

FIG. 1A is an exploded perspective view of a plurality of systems including a polarizer on a wafer level;

FIG. 1B is a perspective view of wafers of FIG. 1A secured together;

FIG. 1C is a cross-sectional view of an individual system of the plurality of systems of FIG. 1A;

FIG. 2 is a slightly exploded cross-sectional view of a device including a polarizer; and

FIG. 3 is a slightly exploded cross-sectional view of a single system including a polarizer.

### DETAILED DESCRIPTION

The present invention will be described in detail through embodiments with reference to accompanying drawings. However, the present invention is not limited to the following embodiments but may be implemented in various types. The preferred embodiments are only provided to make the disclosure of the invention complete and make one having an ordinary skill in the art know the scope of the invention. The thicknesses of various layers and regions are emphasized for clarity in accompanying drawings. Also, when a layer is defined to exist on another layer or a substrate, the layer may exist directly on another layer or substrate, or an interlayer layer may be present therebetween. Throughout the drawings, the same reference numerals denote the same elements.

The ability to create polarization control elements by patterning a material on a substrate allows polarizers to be created on a wafer level. The pattern may be in a material, such as a conductive material, on the substrate or may be transferred into the substrate. Such creation may then be used, in accordance with the present invention, to integrate polarization control elements with other optical elements before singulation thereof, making the efficient creation of micro-optical systems with polarization control elements realizable.

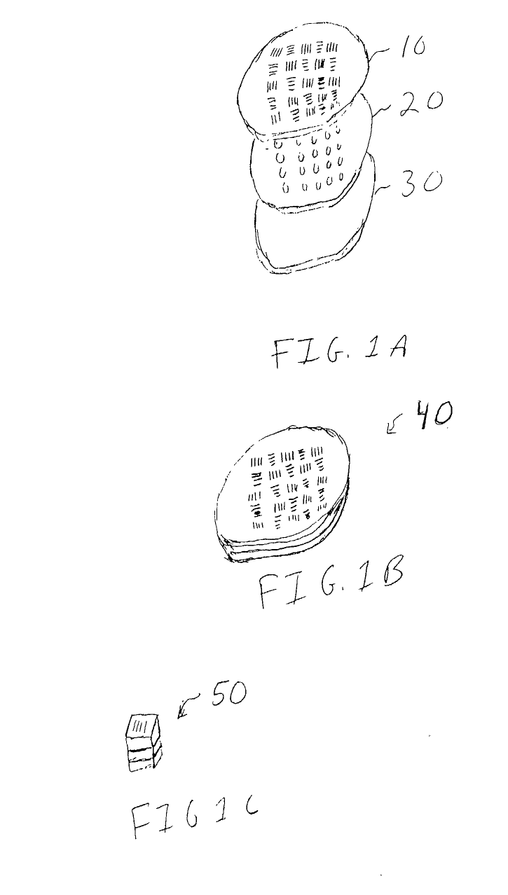

An illustration of such wafer level integration is illustrated in FIGS. 1A-1C. As shown in FIG. 1A, a polarization wafer 10 having polarization control elements 12 lithographically created thereon, an optical wafer 20 having lithographically created optical elements 22, and another wafer 30 are to be aligned and secured. The another wafer 30 may have other optical elements and/or polarization control elements thereon, or may serve as a spacer. As shown in FIG. 1B, these wafers 10, 20, 30 are secured together after alignment and then singulated to form an individual die 50, shown in FIG. 1C. By securing the polarization wafer 10 to at least one other wafer and then singulating the pair of wafers, effective integration of polarization control elements into an optical system may be achieved. Such aligning and securing is set forth, for example, in U.S. Pat. No. 6,096,155, which is hereby incorporated by reference in its entirety for all purposes.

In accordance with the present invention, the polarization control elements may be lithographically created using a mask. Photoresist on a material, e.g., aluminum or the substrate itself, to be used for the polarization control elements is exposed using the mask. The material is then etched in accordance with the pattern in the photoresist, resulting in the polarization control elements.

Due to the lithographic manner of creating these polarization control elements 12, the polarization control elements 12 may be different or the same, depending on the micro-optical systems to be created. Additionally, while the singulation shown in FIG. 1C results in a single polarization control element 12 in the die 50, a plurality of these elements may be present. Further, while the polarization control elements 12 completely populate the polarization wafer 10, including forming a single polarization control element across the entire wafer with no breaks, there may be other optical elements or nothing on portions of the polarization wafer 10. Finally, the surface opposite the polarizing elements could have elements formed thereon.

The above is only one example of the integrated devices that may be formed. The wafers may be secured in any appropriate order. The optical elements may include lens elements, i.e., elements having optical power, splitters, gratings, filters, electro-optical elements. Instead of or in addition to, the wafers may include any structure that can be created lithographically, i.e., by either adding or subtracting material on the wafer using a mask. Any number of wafers may be secured together.

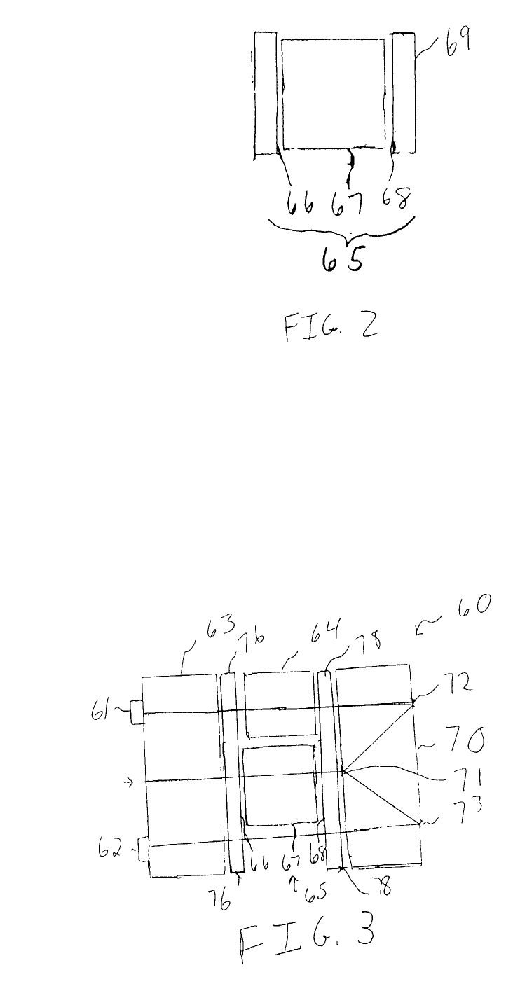

Any polarization use, e.g., any wave plate, retarder, compensator, may be realized from the polarization control elements 12. As a particular example of a device incorporating a polarization control element, an isolator 65 is shown in FIG. 2. This view is slightly exploded for ease of explanation, but in practice, these elements would all be secured together. An isolator is used to permit a transmitted beam from a source to pass in the desired direction, but a prevent a beam reflected back towards the source from being incident on the source.

The isolator 65 includes a non-reciprocal rotation mechanism 67 between a pair of polarization control elements 66, 68, which are typically linear polarizers. The non-reciprocal rotation mechanism 67 is an element that rotates the polarization of light in the same direction regardless the beam's propagation direction along the axis of the mechanism. Placing such a mechanism between properly oriented polarization control elements allows light to pass in one direction, but not the opposite direction. Examples of the non-reciprocal rotation mechanism 67 include materials exhibiting a magneto-optic effect, such as the Faraday effect. The planes of polarization of the polarization elements 66, 68 are rotated by some amount relative to one another. This offset is determined by the amount of rotation provided by the non-reciprocal mechanism 67, so a maximum amount of light will be transmitted from the polarization element 68. The amount of rotation provided by the non-reciprocal rotation mechanism 67, and hence the offset, is typically 45°, since this allows the optimal degree of isolation.

As can be seen from FIGS. 1A-1C, this isolator can be formed on the wafer level, with the wafer 10 including the polarizing element 66, the wafer 20 including the non-reciprocal rotation mechanism 67, and the wafer 30 including polarizing elements 68. If non-reciprocal rotation mechanism 67 is made of a material available in wafer form, all the wafer 10, 20, 30 may be simply aligned and secured together. If the non-reciprocal rotation mechanism is not available in wafer form, or is very expensive, the non-reciprocal rotation mechanism 67 may be made the desired size and die bonded to one of the wafers 10, 30 using a pick-and-place device. When the non-reciprocal rotation mechanism 67, e.g., garnet, operates by a magneto-optic effect, a fixed magnet may be attached to two opposing surfaces of the non-reciprocal rotation mechanism. The surfaces selected will depend on accessibility of the surfaces and the plane of rotation of the non-reciprocal rotation mechanism. The magnets may be attached before singulation, e.g., die bonded along with the non-reciprocal rotation mechanism, attached after singulation, but before incorporation into another system, or attached after incorporation into another system. Since the magnets tend to be heavier than the remainder of the isolator, the pre-incorporation attachment of the magnets may hinder alignment of the isolator in a system.

Since the lithographically created polarization control elements of the present invention rely on surface phenomenon, rather than on the material itself as do polarization plates, for polarization control, other elements may be formed on either the same surface or an opposite surface. Such elements may include an optical element having power therein, e.g., diffractive or refractive lens elements, splitters, filters, further polarization control elements or any element that may be created lithographically. As an example, another polarization control element 69, e.g., a phase retarder, may be formed on an opposite surface of the polarization control element 68 of the isolator. Some components in the system may be optimized for a particular polarization, so the isolator rotation may need to be compensated, e.g., using a phase retarder. A phase retarder functions by presenting different polarizations with different optical path lengths. This may be achieved, for example, by providing birefringent structures that will present different refractive indices for different polarizations. Thus, further polarization control may be included without requiring an additional element.

As a particular example of a micro-optical system incorporating a polarization element, and further illustrating the benefits of integrating polarizing elements on the wafer level, a wavelength monitor 60 is shown in FIG. 3. This view is slightly exploded for ease of explanation, but in practice, these elements would all be secured together. This monitor 60 generally includes a support substrate 63, a wavelength discriminating element 64, an isolator 65 and an optical substrate 70. The ceramic substrate 63 supports two detectors 61, 62. The wavelength discriminating element 64 may be, for example, a filter or series of filters, an etalon, or an interferometer. The optical substrate 70 includes a splitter 71 and reflective portions 72, 73.

Light from a source passes through the support substrate 63, the isolator 65 and is incident on the splitter 71. The splitter 71 creates more than one beam from the input beam. If the wavelength monitor is monitoring an application beam, the remainder of the beam not split off by the splitter 71 passes through the optics substrate 70 to the application. The split off portions are incident on respective reflective portions 72, 73. As shown in FIG. 3, these reflective portions may have optical power integrated therein to orthogonally direct the beams. One beam is directed to the wavelength discriminating element. 64 and then onto the detector 61. The other beam serves as the reference beam and is directed onto the detector 62. Any light reflected in the system that is directed back towards the light source is prevented from impinging on the light source by the isolator 65.

As in FIG. 2, the isolator includes the rejection mechanism 67 between the pair of polarization elements 66, 68. While this structure could be directly integrated, e.g., using pick and place to mount the isolator 65 on the support substrate 63 or the optical substrate 70, here the substrates 76, 78 including the polarizing elements 66, 68 extend beyond the region of the isolator 65. This extension eases the integration of the polarization elements into the system 60. Other optical elements, such as anti-reflective coatings, diffractive elements, reflective coatings or wavelength selective filters may be included on the substrate 76 and/or substrate 78 in desired positions. If a wavelength selective filter or an air gap etalon is to be used as the wavelength discriminating element, the elements required for such discrimination could be provided on the substrates 76, 78, allowing the separate element 64 to be eliminated. Either substrate 76, 78 may serve as the support for the rejection mechanism 67 and/or the wavelength discriminating element 64. The resulting integrated structure may then be readily aligned and secured to the optical substrate 70 and/or the support substrate, and then singulated. Thus, integration of the system on the wafer level is facilitated.

In another alternative where the polarizing element is to be integrated with other elements formed on the wafer level, the polarizing elements could be formed on a same substrate or surface as other elements. For example, in FIG. 3, one or both of the polarizing elements 76, 78 could be formed on the adjacent substrate 63, 70, if it was of a suitable material.

Thus in accordance with the present invention, the wafer-level creation of polarization elements and securing of a wafer containing such polarization elements with at least one other wafer facilitates the integration of polarization elements into micro-optical devices/systems. While lithographic techniques for forming the polarization control elements offer the greatest flexibility, other wafer level formation techniques that result in a polarization control element including a pattern on a surface of the substrate may also be used to integrate the polarization control element in accordance with the present invention. These other techniques may be used in conjunction with lithographic techniques. Again, other optical elements may be formed on a surface of the substrate opposite the polarization control elements.

While the present invention is described herein with reference to illustrative embodiments for particular applications, it should be understood that the present invention is not limited thereto. Those having ordinary skill in the art and access to the teachings provided herein will recognize additional modifications, applications, and embodiments within the scope thereof and additional fields in which the invention would be of significant utility without undue experimentation. For example, only one of the substrates having the polarization elements could be extended. Thus, the scope of the invention should be determined by the appended claims and their legal equivalents, rather than by the examples given.

What is claimed is:

1. An optical device comprising:
a substrate containing at least two elements;
a polarization control element including a pattern formed on a surface of the substrate; and
a lithographically created element on the substrate.

2. The optical device of claim 1, wherein the lithographically created element is a lens.

3. The optical device of claim 1, wherein the lithographically created element is another polarization control element.

4. The optical device of claim 3, wherein the another polarization control element is presents a different degree of rotation than the polarization control element.

5. The optical device of claim 4, wherein the lithographically created element is a phase retarder.

6. The optical device of claim 5, wherein the phase retarder is on an opposite surface, as the polarization control element.

7. The optical device of claim 3, wherein another polarization control element and the polarization control element are on the same surface of the substrate.

8. The optical device of claim 1, wherein the pattern is in a material on the surface of the substrate.

9. The optical device of claim 1, wherein the pattern is created using lithography.

10. An optical device comprising:
a first polarization control element including a first pattern on a surface of a substrate; and
a second polarization control element including a second pattern on the surface of the substrate, the first and second patterns being different from one another.

11. The optical device of claim 10, wherein at least one of the first and second patterns is created using lithography.

12. The optical device of claim 10, wherein at least one of the first and second patterns is in a material on the surface of the substrate.

13. The optical device of claim 10, wherein at least one of the first and second patterns is in the surface of the substrate.

14. The optical device of claim 10, wherein the first and second polarization control elements have different orientations from one another.

15. The optical device of claim 14, wherein the orientations are orthogonal.

16. An optical system comprising:
a first substrate receiving a light beam from a light source;
a second substrate secured to the first substrate;
an optical isolator in a path of the light beam, the optical isolator including;
a first polarization control element including a first pattern on one of the first and second substrates or any substrate secured thereto,
a second polarization control element including a second pattern on one of the first and second substrates or any substrate secured thereto, and
a non-reciprocal mechanism between the first and second polarization elements;
a lithographically created element on one of the first and second substrates or any substrate secured thereto.

17. The optical system of claim 16, wherein the lithographically created element is a splitter.

18. The optical system of claim 16, wherein the lithographically created element is a lens.

19. The optical system of claim 16, wherein the lithographically created element is a phase retarder.

20. A method of making an optical device, the method comprising:
forming a plurality of polarization control elements on a first substrate, each polarization control element including a pattern on a surface of the first substrate;
aligning a second substrate to the first substrate;
securing aligned first and second substrates; and
singulating secured first and second substrates to form dies including at least one polarization control element.

21. The method of claim 20, further comprising lithographically forming optical elements on at least one of the first and second substrates before said aligning.

22. The method of claim 20, further comprising forming another plurality of polarizing elements on the second substrate and sandwiching a non-reciprocal mechanism between the pluralities of polarizing elements on the first and second substrates before said aligning.

23. The method of claim 22, wherein the non-reciprocal mechanism is a plurality of discrete mechanisms and said sandwiching includes securing the non-reciprocal mechanisms to one of the first and second substrates before said singulating.

24. The method of claim 20, further comprising lithographically forming lens elements on at least one of the first and second substrates before said aligning.

25. The method of claim 20, further comprising forming further polarization control elements on the one of the first and second substrates before said aligning.

26. The method of claim 25, wherein said forming further polarization control elements includes forming further polarization control elements on the first substrates opposite the plurality of polarization control elements.

27. The method of claim 20, wherein said forming includes using lithography in creating the pattern.

28. A method of making an optical device, the method comprising:
creating a first polarization control element on a surface of a substrate, the first polarization control element including a first pattern on the substrate; and
creating a second polarization control element on the surface of the substrate, the second polarization control element including a second pattern on the substrate, the first and second patterns being different.

29. The method of claim 28, further comprising singulating the substrate to form dies including at least one polarization control element.

30. The method of claim 28, wherein said creating of the first and second polarization control elements includes using lithography.

31. The method of claim 28, further comprising lithographically creating an element on the substrate.
